(19) United States
(12) Patent Application Publication
(10) Pub. No.: US 2007/0057002 A1
(43) Pub. Date: Mar. 15, 2007

(54) Shoulder strap and waist belt bag

(76) Inventors: Christian Timm, Schenectady, NY (US); Inna Spektor, Niskayuna, NY (US); Nancy Gold, Niskayuna, NY (US)

Correspondence Address: TOUGH TRAVELER LTD., 1012 STATE ST., SCHENECTADY, NY, 12307, US

(21) Appl. No.: 11/509,284

(22) Filed: Aug. 24, 2006

Related U.S. Application Data
(60) Provisional application No. 60/715,166, filed on Sep. 9, 2005.

(51) Int. Cl. A61G 1/00; A45F 5/02; A45F 3/02

(52) U.S. Cl. 224/625; 224/236; 224/159

(57) ABSTRACT

The present shoulder strap and waist belt invention is conceived to help the person who must carry weight comfortably and access the contents while carrying that weight. A person practiced in the art may imagine a number of deviations in the scope of this invention. One imagined deviation is a substitution of the bag for a more shelf-like creation which would be useful to people with injuries that need time for rest, such as an injured arm: Additional padding, webbing, and means of attachment of additional pieces could allow superior rest for the injured limb. Other deviations come to mind: a child carrier; a dog or other small pet carrier; a book or papers carrier without the external bag but instead with a grill-like cage or other means of containment, and others. As new raw materials are invented, substitutions may be made while using or otherwise keeping the ideas of the present invention. While the embodiment of the present invention teaches a soft bag with a small rigid section, a more fully rigid or completely rigid case may be imagined by one practiced in the arts, including a more rigid system of attachment of the case to the waist belt. Gel materials with imbedded shorter pieces such as aluminum, a pliable plastic, and other materials may be imagined, along with, or independent of, additional constructions and material changes as may be imagined by one practiced in the arts. The ability to carry weight comfortably while accessing the contents regularly will be of importance to walking delivery people, but utilization of this invention may well be more expansive. The current messenger bag trend may wane, and people young and old who are attracted by the informality of messenger bags but who want more comfort, may use the present shoulder strap and waist belt bag invention for school, work, and travel.

### CROSS REFERENCE TO RELATED APPLICATIONS

Provisional Patent App. 60/715166

### STATEMENT REGARDING FED-SPONSORED R&D

This invention had no federally sponsored research and development

### REFERENCE TO SEQUENCE LISTING, A TABLE, OR A COMPUTER PROGRAM LISTING APPENDIX

There is none

### BACKGROUND OF THE INVENTION

There are many bags with waist belts, and there are many bags with shoulder straps. Generally, these bags have either a waist belt or they have a shoulder strap or shoulder straps. However, it is not novel to find a bag held mainly with shoulder strap and then an optional, or not optional, waist belt, or a bag held on the waist with an optional, or not optional, shoulder strap. Likewise, with the current trend of one-shouldered bag or backpack, dual use of a waist belt and a single strap—in this instance, across the chest in a diagonal manner—is common.

The problem with these bags and backpacks is that they may allow carrying what is needed, but they do not always keep the wearer comfortable or the contents easily accessible or usable while the bag or backpack is being worn by the person. These bags may keep the load primarily on the shoulder, particularly as the weight of the load increases: Bags that are used for carrying light weight or are of small size can be comfortable, but as the size of the load or the weight of the load becomes bigger, these bags can become quite uncomfortable. Also, the bags may become unwieldy, making walking difficult due to the weight felt on shoulder and the awkwardness—in the case of a bag hanging below the waist—of a bag hitting the lower back and/or leg area of the wearer. Sagging bags may also make access to or use of contents difficult, as the contents move to the lower center point of the bag in the case of a bag with one large or with a plethora of large compartments or pockets. If it is attempted to bypass this gathering of contents by utilizing small interior or exterior compartment or pocket, then it may be difficult to access the individual content items, and the bag may yet sag.

A hard case or bag may solve some of the organizational or access problems, but a hard case or bag presents problems of discomfort and inaccessibility. A hard case or bag is difficult to wear close to the human body because, while the case or bag may be rigidly geometric, the human body is flexible and unevenly curved, making carrying heavy if the weight is on shoulder, or impossible to bend or move if the weight is against back or hip.

### BRIEF SUMMARY OF THE INVENTION

The present shoulder strap and waist belt invention solves the problems of carrying weight and accessibility while providing comfort for shoulder and back. This invention allows a bag or case to be connected to a waist belt where the human waist most bends—at the side of the hip—and for contents to be accessible and comfortable while the bag is being worn, without sagging or weight discomfort. In the instance of the present embodiment of the shoulder strap and waist belt bag invention, a system of interlocking elastic with web, threaded by an aluminum rod, keeps the bag or case attached to the waist belt at one area.

The present invention distributes weight, primarily to the wearer's hips, by keeping one part of the bag or case rigid while connected to the waist belt, and while keeping the waist belt against the wearer's body. The bag is fixed on the waist belt, but all sections of the contents can be accessed either directly or by movement of the waist belt, and the weight is held primarily at the wearer's waist or hips. The waist belt can be tightened while the bag basically stays straight. The shoulder strap allows the waist belt to stay closer to the wearer's body, as the shoulder strap is attached to the waist belt rather than to the bag or case. Most of the weight is at the wearer's hips rather than at the wearer's shoulder, and the shoulder strap, albeit helpful, may be optional, particularly with lighter loads. The rigidity of at least part of the bag or case, in addition to its placement, allows the wearer to walk without awkwardness or discomfort. The shoulder strap is in line with the bag or case, and the use of elastic provides shock absorption when the wearer is walking. To allow quick-discard of the bag or case in the event of an emergency, and also for ease of wearing when the invention is being used, there are connecting points at both where the shoulder strap meets the waist belt and where the waist belt meets with itself.

While the present invention is thought to be of ultimate function when worn at the side, and also movable in part to the front of the wearer, it is possible that the wearer will wear the bag or case at his or her back, turning it when access to compartments is needed. Without use of shoulder strap(s), the entire bag or case supported by the waist belt only may be turned more completely. Additionally, the bag-to-waist belt connections may instead be made on the wearer's front/bag front.

Although the present invention uses a bag of large capacity and rectangular horizontal dimensions, a myriad of sizes and dimensions may be conceived. Simple changes such as the material of shoulder strap in cotton and tricot rather than padded nylon, may be imagined, as well as more complex changes in material. The waist belt may be solidly padded nylon, it may have alternating padding, it may have stays with or without padding, or it may have a plastic basis; other changes to the waist belt in structure and in material may also be imagined. Likewise, the bag or case itself may fully padded, may be a framed structure with solidly or with alternating thinner areas, may have an unframed unpadded structure with one rigid area, or may have alternative structures. Even a rigid case may be used. The invention may have an integral bag, or it may have an existing bag modified by the addition of attachment elastic pieces, aluminum pieces, plastic pieces, and/or other substitutions to complete the invention. Optional compression straps; compartments both in the interior and on the exterior of the bag or case; different arrangements of shoulder strap or even the addition of a second strap; compartments on the waist belt; these and other modifications may be imagined by one practiced in the arts. Likewise, alternative placements and use of plastic hardware, web, hook and loop, quick-release buckles, bolts, screws, nuts, clips, and other connecting materials, both invented or to come, are imagined.

### BRIEF DESCRIPTION OF THE DRAWINGS

FIG. 1 Back view of the present shoulder strap and waist belt bag invention

FIG. 2 Front view the present invention

FIG. 3 Side view showing the bag stretched away from the waist belt, for the purpose of illustration

FIG. 4 Back of bag when it is not connected to waist belt or to shoulder strap, for the purpose of illustration

FIG. 5 Front of bag when it is not connected to waist belt or to shoulder bag, for the purpose of illustration

FIG. 6 Aluminum rod that is used in the present invention, shown removed from the full invention, for the purpose of illustration

FIG. 7 Front view of person wearing the present invention

FIG. 8 Back view of person wearing the present invention

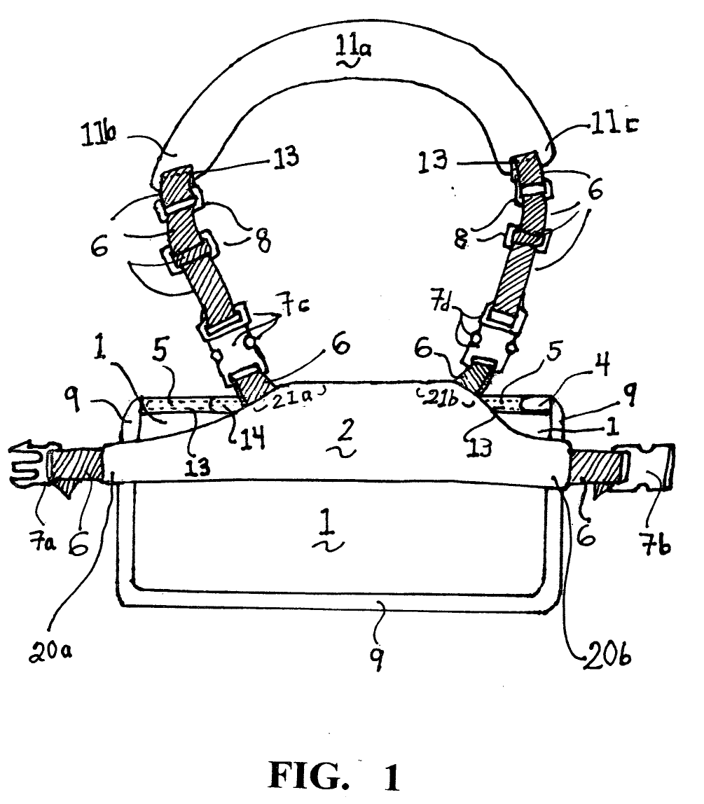

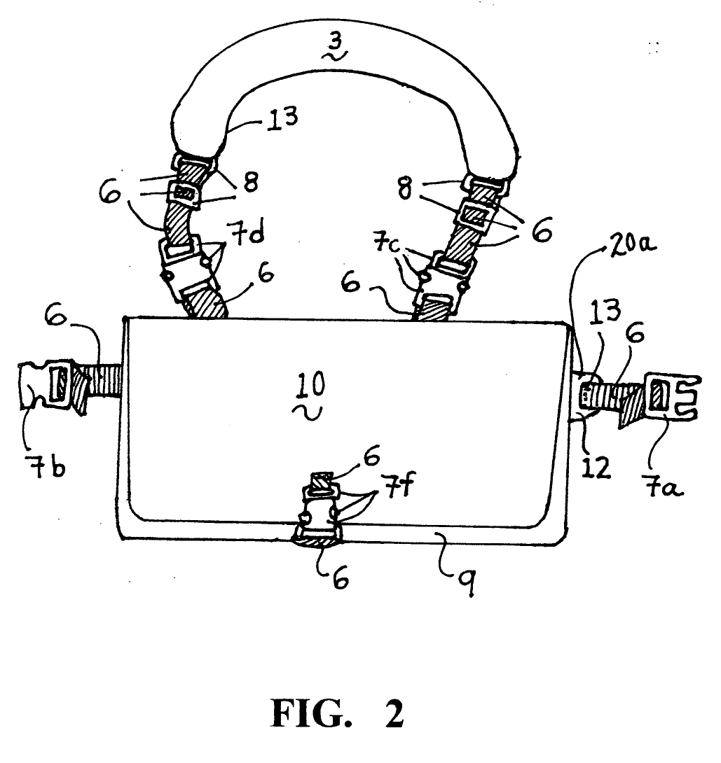

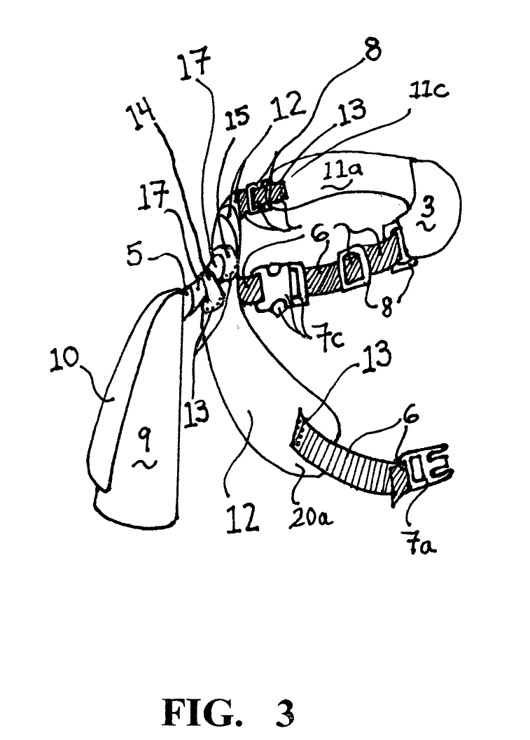

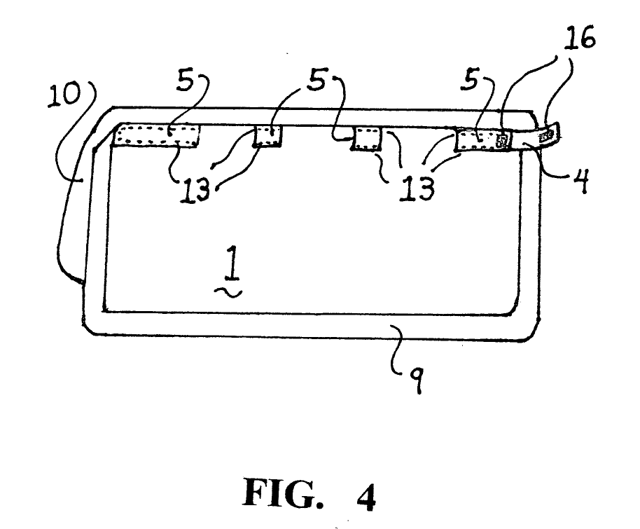

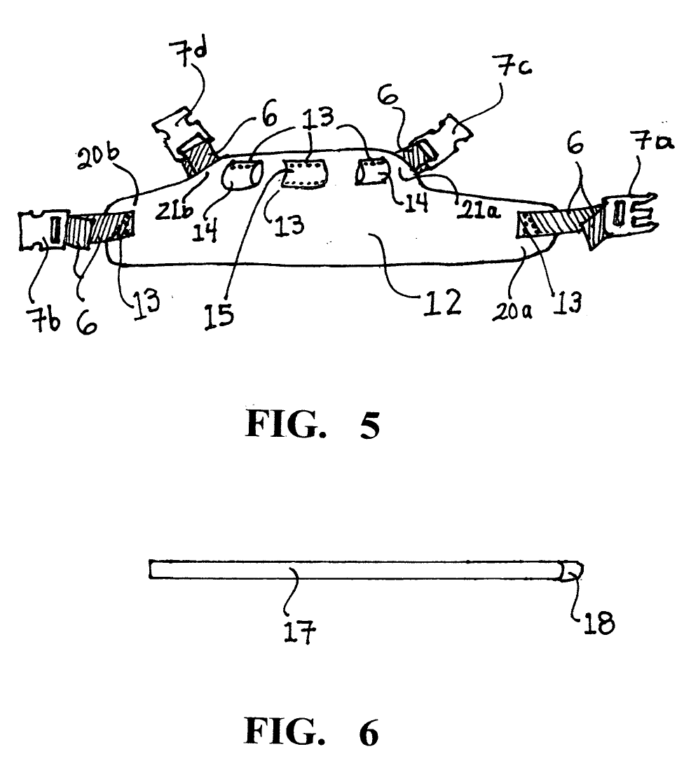

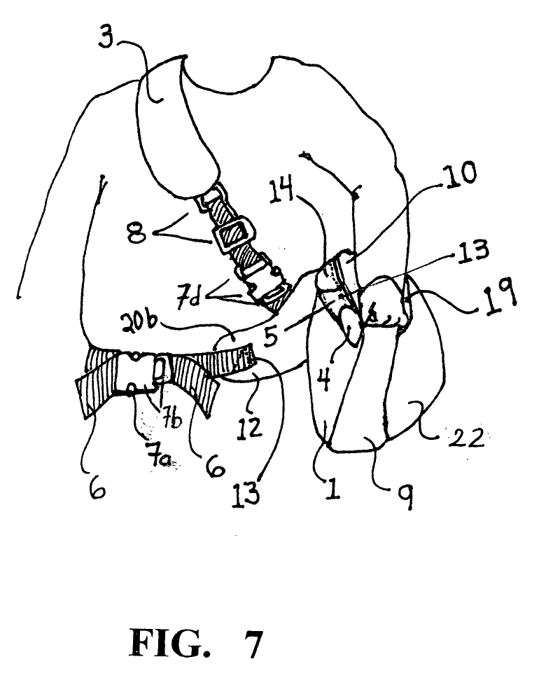

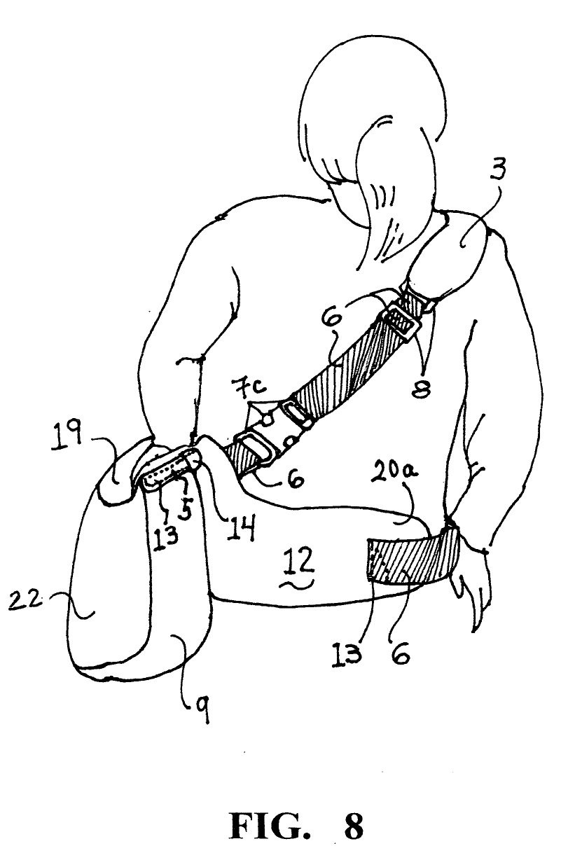

### DETAILED DESCRIPTION

This embodiment of the present shoulder strap and waist belt bag invention has three main structures that interconnect to form the embodiment. The waist belt underside 2, waist belt upper-side 12 connects to itself, or disconnects to itself at ends 20a, 20b with the use of quick-release buckle 7a, 7b, which attach by web pieces 6 and stitching 13. Towards the top of the waist belt 21a, 21b, web pieces 6 connect quick-release buckles 7c, 7d, which connect, or disconnect, with upper-side shoulder strap 3 and underside shoulder strap ends 11b, 11c. The web 6 of the shoulder strap 3, 11a is adjustable through the use of hardware 8.

The bag is comprised of bag back 1, bag gusset 9, bag flap 10, bag inside 19, and bag front 22. At bag back 1 there are four web tunnels 5, with stitching 13, to allow passage of aluminum rod 17. There is a flap 4 to prevent unintentional removal or dislodgement of aluminum rod 17 from web tunnels 5. The flap 4 is closed by hook and loop 16, and there is an end cap 18 on the aluminum rod 17 to allow easier-on-the-hands insertion of the aluminum rod 17. On waist belt upper-side 12 there are two elastic loops 14 and the elastic tunnel 15, both with stitching 13, through which aluminum rod 17 is inserted alternatively with web tunnels 5 of bag back 1 forming the direct connection of the waist belt upper-side 12 and the bag back 1 of this embodiment of the present shoulder strap and waist belt bag invention, and coincidentally forming the fuller connection of the waist belt underside 2, waist belt upper-side 12 and the bag 1, 9, 10, 19, 22. On bag gusset 9, web 6 holds quick-release buckle 7f to allow closure of bag flap 10.

We claim:

1. A wearable apparatus comprising:
a container portion;
a belt portion; and
an attachment device,
wherein the container portion and the belt portion are non-fixedly attached by the attachment device.

2. The apparatus of claim 1, wherein the attachment device includes a rod member adapted to be slidably inserted through at least one sleeve member on each of the container portion and the belt portion.

3. The apparatus of claim 2, wherein the rod member includes aluminum.

4. The apparatus of claim 1, further comprising a shoulder strap member adapted to be non-fixedly attached to the belt portion.

5. The apparatus of claim 4, wherein the container portion is adapted to be located adjacent a hip of a wearer and the shoulder strap member is adapted to be worn adjacent a shoulder of a wearer opposite the support portion.

6. The apparatus of claim 4, wherein a length of the shoulder strap member is adjustable.

7. The apparatus of claim 1, wherein the container portion includes a non-rigid material adapted to contour to a portion of a wearer's body.

8. The apparatus of claim 7, wherein the container portion includes at least one of the following: a gusset and a flap.

9. The apparatus of claim 1, wherein the container portion is adapted to carry an infant.

10. The apparatus of claim 1, wherein the container portion is adapted to carry an animal.

11. A wearable apparatus comprising:
a support portion;
a belt portion; and
an attachment device,
wherein the support portion and the belt portion are non-fixedly attached by the attachment device.

12. The apparatus of claim 11, wherein the attachment device includes a rod member adapted to be slidably inserted through at least one sleeve member on each of the support portion and the belt portion.

13. The apparatus of claim 12, wherein the rod member includes aluminum.

14. The apparatus of claim 11, further comprising a shoulder strap member adapted to be non-fixedly attached to the belt portion.

15. The apparatus of claim 14, wherein the support portion is adapted to be located adjacent a hip of a wearer and the shoulder strap member is adapted to be worn adjacent a shoulder of a wearer opposite the support portion.

16. The apparatus of claim 14, wherein a length of the shoulder strap member is adjustable.

17. The apparatus of claim 11, wherein the support portion is adapted to support an arm of a wearer.
